(19) United States
(12) Patent Application Publication
(10) Pub. No.: US 2018/0194152 A1
(43) Pub. Date: Jul. 12, 2018

(54) BOOK, PREFERABLY NOTEBOOK

(71) Applicant: ONE LIMITED EDITION GmbH, Krefeld (DE)

(72) Inventor: Brigitte TRETSCHOCK, Krefeld (DE)

(21) Appl. No.: 15/867,958

(22) Filed: Jan. 11, 2018

(30) Foreign Application Priority Data
Jan. 11, 2017 (DE) 202017100101.6

(51) Int. Cl. B42C 17/00; B42D 3/02; B42D 3/06

(52) U.S. Cl. CPC B42C 17/00; B42D 3/06; B42D 3/02

(57) ABSTRACT

The invention relates to a book having a multi-part binder and at least one sheet of paper in the binder. The binder has a spine, a front-side book cover pivotable around a first axis, and a rear-side book cover pivotable around a second axis. A holding apparatus detachable mounts the at least one sheet on the binder.

At least one book cover is embodied in multi-part fashion, encompassing a receiving surface fastened articulatedly on the spine and pivotable around the corresponding pivot axis. A replaceable cover element is detachably mountable on the receiving surface. At least one book cover comprises a receiving surface, fastened articulatedly on the spin and pivotable around the corresponding pivot axis, as well as a cover element. The receiving surface and the cover element are integral and the book cover is replaceable thanks to a detachable mounting of the receiving surface on the spine element.

The invention relates to a book, preferably a notebook, having a multi-part binder and at least one sheet of paper or paper-like material received in the binder, the binder encompassing a spine element, a front-side book cover fastened pivotably around a first pivot axis, and a rear-side book cover fastened pivotably around a second pivot axis, and a holding apparatus being provided for detachable mounting of the at least one sheet on the binder.

Notebooks of this kind, in which the book covers and also the spine element are often covered with leather, textile, paper, or a plastic material, are known from practical use. As part of the binder, the book covers serve to protect the sheet, which as a rule is embodied as a notepad. The latter can also be side-bound and preferably has a glue binding.

It is disadvantageous in this context that such notebooks need to be reacquired in their entirety after being completely written in. This is undesirable especially in the context of a binder of high-quality manufacture, and not only is associated with high cost but also represents an undesirable waste of raw materials.

In books that have replaceable “internals” and the notepad can be replaced, however, writing on or otherwise configuring the book cover can also result in a desire for change after the book has been used for a certain period of time, so that complete replacement of the book becomes necessary or desirable.

The object of the invention is to avoid the aforesaid disadvantages and to describe a book with which both replacement of the internals, and adaptation of the book cover to changing requirements, are flexibly possible.

This object is achieved, in a book of the species, in that

either

at least one book cover is embodied in multi-part fashion, encompassing a receiving surface fastened articulatedly on the spine element and pivotable around the corresponding pivot axis, and a replaceable cover element detachably mountable on said receiving surface,

or

at least one book cover comprises a receiving surface, fastened articulatedly on the spine element and pivotable around the corresponding pivot axis, as well as a cover element, the receiving surface and the cover element being embodied integrally and said book cover being replaceable thanks to a detachable mounting of the receiving surface on the spine element.

Advantageously, on the one hand the holding apparatus can comprise or be constituted by a first sub-element of a magnetic mounting system, and on the other hand the at least one sheet can comprise a second sub-element of a magnetic mounting system. Affixing of the “internals” in the book can thus be accomplished in simple fashion by magnetic attachment.

According to the present invention, at least one sub-element of a magnetic mounting system can be embodied as a magnetic strip, and furthermore at least one sub-element of a magnetic mounting system can be embodied as an iron strip. Alternatively, both sub-elements can also be embodied as a magnetic strip.

Advantageously, the at least one sheet and/or the notepad can be equipped with endpapers that project at least 10 mm to a maximum of 20 mm, preferably 15 mm.

The two endpapers can each be folded over facing inward and can be held in clamped fashion between two clamping bars, so that secure mounting of the sheet or notepad is possible.

At least one sub-element of a magnetic mounting system can be attached to the outer clamping bar, being preferably adhesively bonded or bolted on.

Preferably at least one clamping bar can be at least 10 mm to a maximum of 20 mm, preferably 15 mm, wide. At least one clamping bar can also be at least 100 mm to a maximum of 320 mm, preferably 150 mm or 210 mm or 300 mm, long. Secure mounting and good stability are thereby enabled, and usual dimensions of such books are conformed to.

In a preferred exemplifying embodiment of the invention, at least one cover element can be made at least externally, preferably entirely, of a metallic, in particular engraved, material, thereby affording particularly high quality as well as good durability and stability.

According to the present invention, at least one cover element can be detachably mounted on the corresponding receiving surface by way of a screw mounting system. The inner side of the cover element can in that context be equipped with internal threads, and the receiving surface can comprise correspondingly provided passthrough holes, and mounting can be effecting using appropriate screws. Countersunk screws can be utilized in particular, and the passthrough holes can be equipped with a countersink for them.

Advantageously, at least one pivot axis can be constituted by a hinge, preferably in the manner of a piano hinge, thus affording stable and durable articulated support over the entire height of the book.

In a preferred embodiment of the invention, the two cover elements can each be equipped with loops for holding a writing instrument; the loops can be arranged along the outer edges of the cover elements in such a way that with the book in a closed state they are adjacent to, and align with, one another. A pen arranged in the loops by being inserted then locks the two book covers to one another and prevents the book from being opened.

When at least one pivot axis is constituted by a hinge, the hinge can preferably be embodied as a rolled hinge having two leaves that are connected to one another by a pin, the one leaf being part of the spine element and the other leaf being part of the receiving surface.

In a preferred exemplifying embodiment of the invention, the book can furthermore encompass a holder, providable instead of the at least one sheet or as a supplement to that at least one sheet, for a tablet computer or a phablet, which holder likewise comprises a second sub-element of a magnetic mounting system and is detachably attachable by means thereof to the first sub-element of the holding apparatus.

Exemplifying embodiments of the invention are depicted in the drawings and will be explained below. In the drawings:

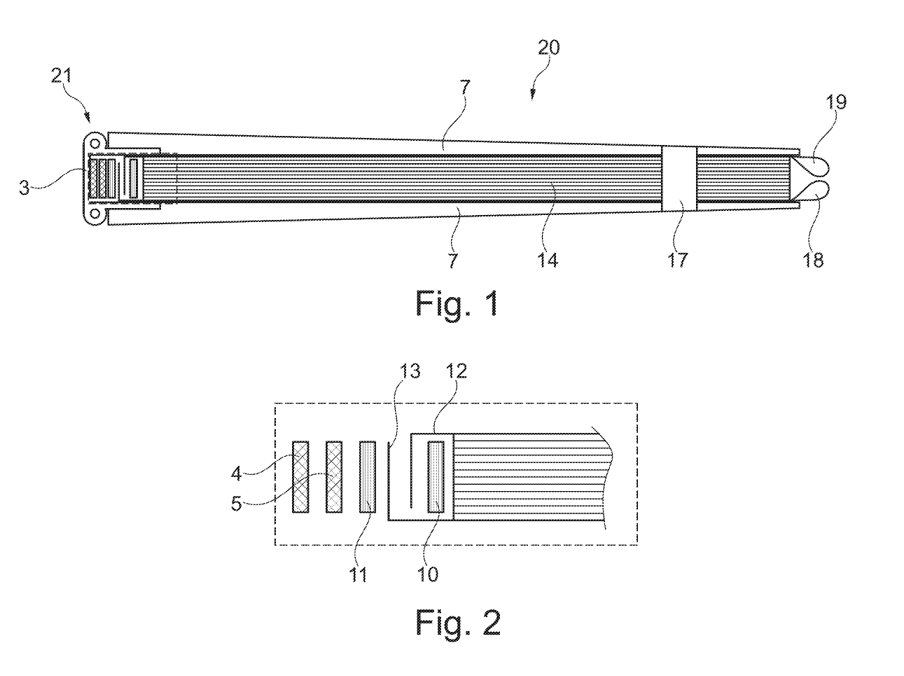

FIG. 1 is a side view of a first exemplifying embodiment of a book according to the present invention;

FIG. 2 is an exploded view showing an enlarged detail of the holding apparatus;

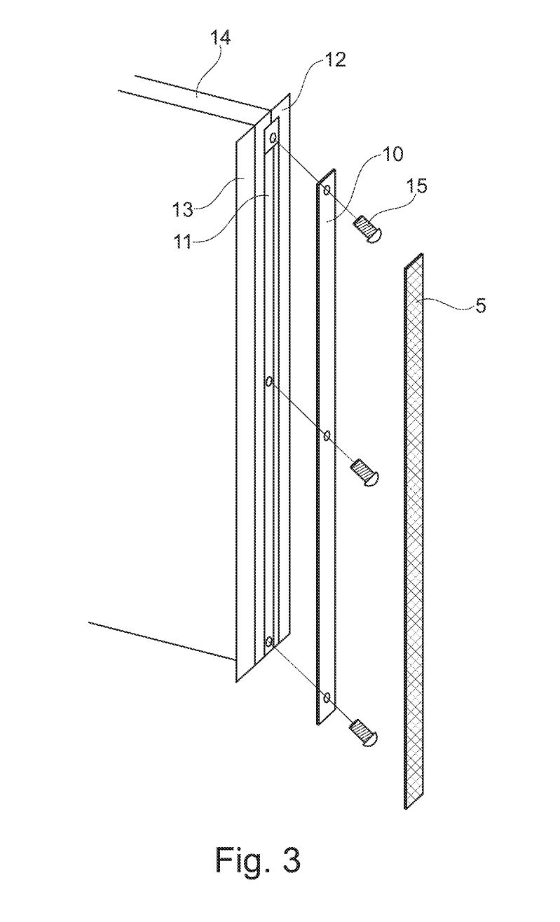

FIG. 3 is a detail view of the holding apparatus as an exploded view;

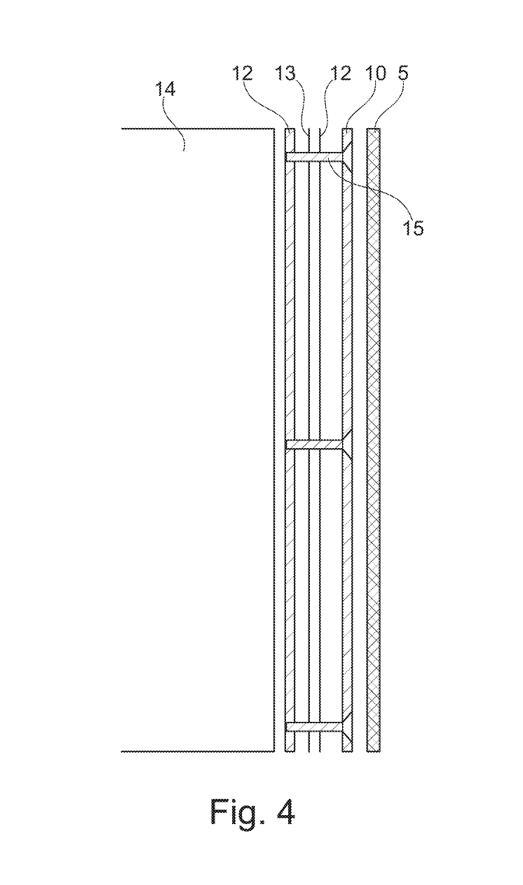

FIG. 4 is a side view, in section, of the subject matter shown in FIG. 3;

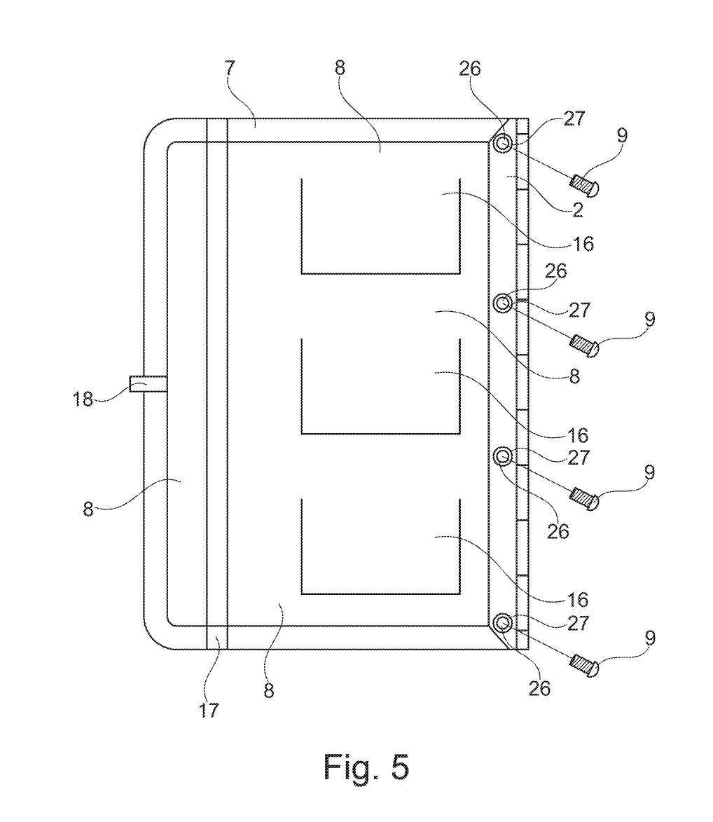

FIG. 5 is a view of the inner side of the front-side book cover;

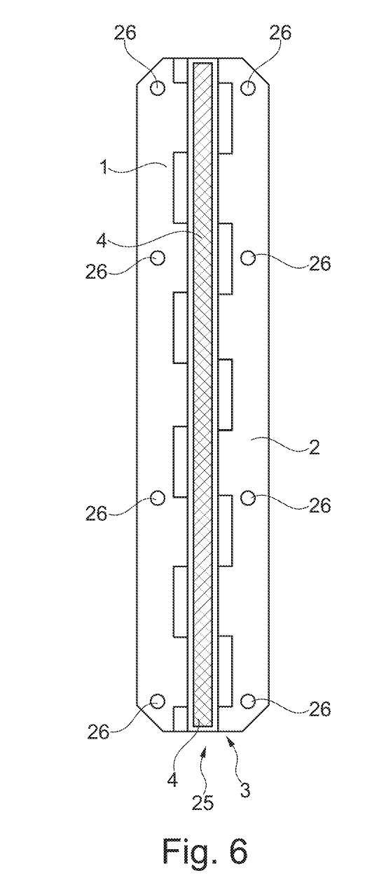

FIG. 6 is a view of the spine element;

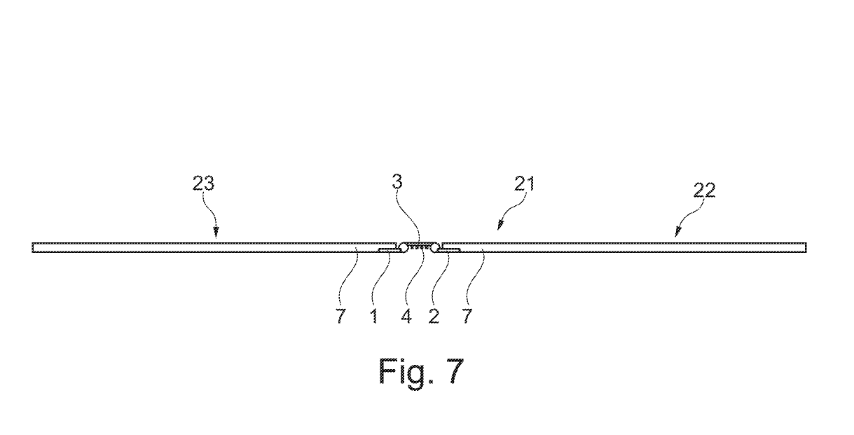

FIG. 7 is a view of the binder of the book; and

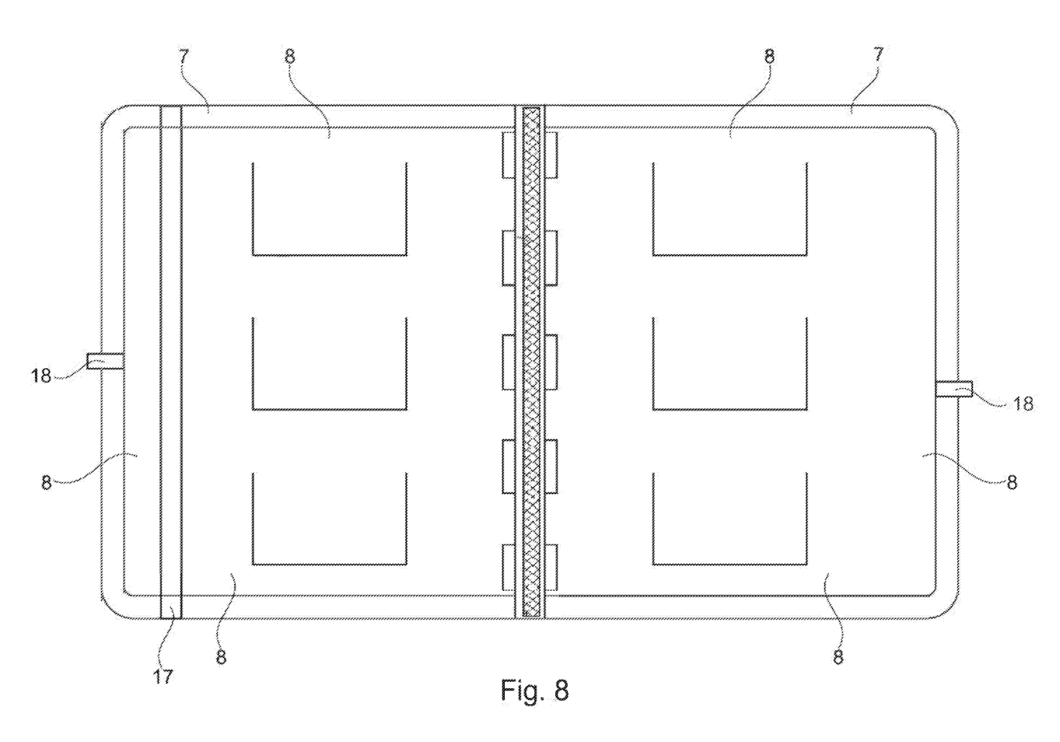

FIG. 8 is a side view of a second exemplifying embodiment of a book according to the present invention.

In all the Figures, corresponding reference characters are used for identical or similar components.

FIG. 1 shows a first exemplifying embodiment of a book 20 having a multi-part binder 21 and at least one notepad 14 that is received in binder 21 and encompasses a number of sheets of paper and is equipped with a glue binding on the side.

As is also evident from FIG. 7, binder 21 encompasses a spine element 3, a front-side book cover 22 fastened pivotably around a first pivot axis, and a back-side book cover 23 fastened pivotably around a second pivot axis.

Book 20 is furthermore equipped with a holding apparatus 24 for detachable mounting of notepad 14 on binder 21.

Both book covers 22, 23 are of multi-part configuration (see FIG. 7). They each encompass receiving surfaces 1, 2 that are fastened articulatedly to spine element 3 and are pivotable around the corresponding pivot axis. A detachably mountable replaceable cover element 7 is then provided on each of receiving surfaces 1, 2.

Cover elements 7 are made entirely of a metallic material. They are each detachably mounted on the corresponding receiving surface 1, 2 via a screw mounting system. For this purpose, receiving surfaces 1, 2 have correspondingly provided passthrough holes 26, and the inner sides of cover elements 7 are equipped with internal threads. Correspondingly adapted screws 9, which in the exemplifying embodiment shown are embodied as countersunk screws, are then provided for mounting. Passthrough holes 26 are accordingly equipped with a countersink 27.

As shown in FIG. 6, the pivot axes are respectively implemented by a hinge 25 that is embodied in the manner of a piano hinge. In the exemplifying embodiment shown, hinge 25 is embodied as a corresponding double hinge, the center region of the double hinge forming spine element 3 of book 20 and the two lateral regions of the double hinge representing receiving surfaces 1, 2 that are connected to one another via stainless steel pins 6.

On the one hand, holding apparatus 24, which can be seen particularly well in FIG. 2, comprises a magnetic strip 5 as a first sub-element of a magnetic mounting system, and on the other hand notepad 14 is equipped with a magnetic strip 4 as a second sub-element of the magnetic mounting system (see FIGS. 3 and 4).

Notepad 14 is outfitted with endpapers 12, 13 that project approximately 15 mm. The two endpapers 12, 13 are each folded over facing inward, and are held in clamped fashion between two clamping bars 10, 11 connected to one another via screws 15. Magnetic strip 5 is in turn mounted on the outer clamping bar 10; in the exemplifying embodiment shown, it is adhesively bonded on. This is clearly evident, for example, from FIGS. 2 and 3.

As is evident from FIGS. 1 and 5, the two cover elements 7 of book 20 are respectively equipped with loops 18, 19 for retaining a writing instrument. Loops 18, 19 are arranged along the outer edges of cover elements 7 in such a way that, with book 1 in a closed state, they are adjacent to, and aligned with, one another. Locking of the book can thus be effected by sliding a pen into the two loops 18, 19, thereby preventing unintentional opening of the book.

FIG. 5 furthermore shows that front cover element 7 is equipped on the inner side with business card pockets 16 and with a rubber band 17 for closing book 20 and/or for marking pages of notepad 14. A large area of the inner side of cover element 7 is embodied as a recessed depression, thereby on the one hand reducing the weight of cover element 7 and also creating room for business card pockets 16.

FIG. 8 shows a second exemplifying embodiment of a book 20 having a multi-part binder 21; in a departure from the first exemplifying embodiment, receiving surface 1, 2 and cover element 7 of the two book covers 22, 23 are each embodied in one piece, and the two book covers 22, 23 are replaceable thanks to detachable mounting of receiving surface 1, 2 on spine element 3.

Hinges 25 that form the pivot axes are embodied here as rolled hinges (also called “single hinges”) that comprise three parts, namely the two leaves, which are made of bent thin sheet metal and encompass the knuckles, and an axis embodied as a pin. The latter is embodied detachably in the present case. For each hinge 25, the one leaf is embodied as part of spine element 3, and the respective other leaf is part of the respective receiving surface 1 or 2.

1. A book (20) having a multi-part binder (21) and at least one sheet of paper or paper-like material received in the binder (21), the binder (21) encompassing a spine element (3), a front-side book cover (22) fastened pivotably around a first pivot axis, and a rear-side book cover (23) fastened pivotably around a second pivot axis, and a holding apparatus (24) being provided for detachable mounting of the at least one sheet on the binder (21),
wherein
either
at least one book cover (22, 23) is embodied in multi-part fashion, encompassing a receiving surface (1, 2) fastened articulatedly on the spine element (3) and pivotable around the corresponding pivot axis, and a replaceable cover element (7) detachably mountable on said receiving surface (1, 2),
or
at least one book cover (22, 23) comprises a receiving surface (1, 2), fastened articulatedly on the spine element (3) and pivotable around the corresponding pivot axis, as well as a cover element (7), the receiving surface (1, 2) and the cover element (7) being embodied integrally and said book cover (22, 23) being replaceable thanks to a detachable mounting of the receiving surface (1, 2) on the spine element (3).

2. The book (20) according to claim 1, wherein on the one hand the holding apparatus (24) comprises or is constituted by a first sub-element of a magnetic mounting system; and on the other hand the at least one sheet comprises a second sub-element of a magnetic mounting system.

3. The book (20) according to claim 2, wherein at least one sub-element of a magnetic mounting system is embodied as a magnetic strip (4, 5).

4. The book (20) according to claim 2, wherein at least one sub-element of a magnetic mounting system is embodied as an iron strip.

5. The book (20) according to claim 1, wherein the at least one sheet is equipped with endpapers (12, 13) that project at least 10 mm to a maximum of 20 mm, preferably 15 mm.

6. The book (20) according to claim 1, wherein the two endpapers (12, 13) are each folded over facing inward and are held in clamped fashion between two clamping bars (10, 11).

7. The book (20) according to claim 1, wherein at least one sub-element of a magnetic mounting system is attached, preferably adhesively bonded or bolted, to the outer clamping bar (10).

8. The book (20) according to claim 6, wherein at least one clamping bar (10, 11) is at least 10 mm to a maximum of 20 mm, preferably 15 mm, wide.

9. The book (20) according to claim 6, wherein at least one clamping bar (10, 11) is at least 100 mm to a maximum of 320 mm, preferably 150 mm or 210 mm or 300 mm, long.

10. The book (20) according to claim 1, wherein at least one cover element (7), and preferably also the spine element, is made at least externally, preferably entirely, of a metallic, in particular engraved, material.

11. The book (20) according to claim 1, wherein at least one cover element (7) is detachably mounted on the corresponding receiving surface (1, 2) by way of a screw mounting system.

12. The book (20) according to claim 1, wherein at least one pivot axis is constituted by a hinge (25), preferably in the manner of a piano hinge.

13. The book (20) according to claim 1, wherein the two cover elements (7) are each equipped with loops (18, 19) for holding a writing instrument, the loops (18, 19) being arranged along the outer edges of the cover elements (7) in such a way that with the book (1) in a closed state they are adjacent to, and align with, one another.

14. The book (20) according to claim 1, wherein the at least one sheet is embodied as a notepad (14) that preferably is side-bound, advantageously by means of a glue binding.

15. The book (20) according to claim 12, wherein when at least one pivot axis is constituted by a hinge (25), the hinge (25) is embodied as a rolled hinge having two leaves that are connected to one another by a pin, the one leaf being part of the spine element (3) and the other leaf being part of the receiving surface (1, 2).

16. The book (20) according to claim 2, wherein the book (20) furthermore encompasses a holder, providable instead of the at least one sheet or as a supplement to that at least one sheet, for a tablet computer or a phablet, which holder likewise comprises a second sub-element of a magnetic mounting system and is detachably attachable by means thereof to the first sub-element of the holding apparatus (24).

17. The book (20) according to claim 3, wherein at least one sub-element of a magnetic mounting system is an iron strip.

18. The book (20) according to claim 2, wherein the at least one sheet is equipped with endpapers (12, 13) that project at least 10 mm to a maximum of 20 mm, preferably 15 mm.

19. The book (20) according to claim 3, wherein the at least one sheet is equipped with endpapers (12, 13) that project at least 10 mm to a maximum of 20 mm, preferably 15 mm.

20. The book (20) according to claim 4, wherein the at least one sheet is equipped with endpapers (12, 13) that project at least 10 mm to a maximum of 20 mm, preferably 15 mm.
